(19) United States
(12) Patent Application Publication
(10) Pub. No.: US 2026/0163773 A1
(43) Pub. Date: Jun. 11, 2026

(54) POLAR ENCODING WITH PHASE ERROR PROTECTION

(71) Applicant: QUALCOMM Incorporated, San Diego, CA (US)

(72) Inventors: Kirill IVANOV, La Jolla, CA (US); Wei YANG, San Diego, CA (US); Mahmoud TAHERZADEH BOROUJENI, San Diego, CA (US); Pinar SEN, San Diego, CA (US)

(21) Appl. No.: 18/972,792

(22) Filed: Dec. 6, 2024

(51) Int. Cl. H04L 27/12

(52) U.S. Cl. CPC H04L 27/12

(57) ABSTRACT

A wireless node may one or more memories, individually or in combination, having instructions. A wireless node may one or more processors, individually or in combination, configured to execute the instructions and cause the apparatus to: generate encoded data by using at least one of a first block of u-domain bits comprising a first u-domain bit being a frozen bit and further being indicative of a phase associated with transmission of the first block via the encoded data; and output the encoded data for transmission.

### BACKGROUND

### Technical Field

The present disclosure generally relates to communication systems, and more particularly, to polar encoding with phase error protection.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some aspects, the techniques described herein relate to an apparatus for wireless communication, including: one or more memories, individually or in combination, having instructions; and one or more processors, individually or in combination, configured to execute the instructions and cause the apparatus to: generate encoded data by using at least one of a first block of u-domain bits including a first u-domain bit being a frozen bit and further being indicative of a phase associated with transmission of the first block via the encoded data; and output the encoded data for transmission.

In some aspects, the techniques described herein relate to an apparatus for wireless communication, including: one or more memories, individually or in combination, having instructions; and one or more processors, individually or in combination, configured to execute the instructions and cause the apparatus to: decode encoded data to obtain at least a first block of u-domain bits including a first u-domain bit being a first frozen bit; and measure a phase error associated with the first block based on a value of the first u-domain bit and a network-related value.

In some aspects, the techniques described herein relate to a method for wireless communication at a wireless node, including: generating encoded data by using at least one of a first block of u-domain bits including a first u-domain bit being a frozen bit and further being indicative of a phase associated with transmission of the first block via the encoded data; and outputting the encoded data for transmission.

In some aspects, the techniques described herein relate to a method for wireless communication at a wireless node, including: decoding encoded data to obtain at least a first block of u-domain bits including a first u-domain bit being a first frozen bit; and measuring a phase error associated with the first block based on a value of the first u-domain bit and a network-related value.

In some aspects, the techniques described herein relate to an apparatus, comprising: means for generating encoded data by using at least one of a first block of u-domain bits including a first u-domain bit being a frozen bit and further being indicative of a phase associated with transmission of the first block via the encoded data; and means for outputting the encoded data for transmission.

In some aspects, the techniques described herein relate to an apparatus, comprising: means for decoding encoded data to obtain at least a first block of u-domain bits including a first u-domain bit being a first frozen bit; and means for measuring a phase error associated with the first block based on a value of the first u-domain bit and a network-related value.

In some aspects, the techniques described herein relate to a non-transitory computer-readable medium comprising instructions that, when executed by a wireless node, cause the wireless node to perform a method, including: generating encoded data by using at least one of a first block of u-domain bits including a first u-domain bit being a frozen bit and further being indicative of a phase associated with transmission of the first block via the encoded data; and outputting the encoded data for transmission.

In some aspects, the techniques described herein relate to a non-transitory computer-readable medium comprising instructions that, when executed by a wireless node, cause the wireless node to perform a method, including: decoding encoded data to obtain at least a first block of u-domain bits including a first u-domain bit being a first frozen bit; and measuring a phase error associated with the first block based on a value of the first u-domain bit and a network-related value.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a block diagram illustrating an example disaggregated base station architecture.

FIG. 5 illustrates an example of a wireless communications system that supports modified polar coding in accordance with various aspects of the present disclosure.

FIG. 6 illustrates an example of diagram of a polar code that supports special bit distribution in accordance with various aspects of the present disclosure.

FIG. 7 is a call-flow diagram illustrating example communications between a transmitting device (e.g., user equipment (UE)) and a receiving device (e.g., network entity).

FIG. 8 is a flowchart of a method of wireless communication.

FIG. 9 is a diagram illustrating an example of a hardware implementation for an example apparatus.

FIG. 10 is a flowchart of a method of wireless communication.

FIG. 11 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Polar encoding with a code of size (N=2^{m}, K) involves using a linear transformation based on the Kronecker power of a 2×2 matrix to encode K information bits into a codeword of length N, where Nis always a power of 2 (e.g., “2^{m}”), effectively creating “polarized” subchannels that allow for efficient transmission over a noisy channel (W), with one or more information subchannels carrying data bits (K) and the remaining subchannels carrying “frozen” bits set to a predetermined value based on the channel characteristics. In other words, the matrix is configured to polarize 2^{m} copies of the channel (W) into subchannels (W⁽ⁱ⁾) that are wither almost noisy (I(W⁽ⁱ⁾)→0) and almost noise-less (I(W⁽ⁱ⁾)→1).

Channel estimation is a critical process in wireless communication systems. In some examples, the goal of channel estimation is to accurately determine a channel matrix (H) so that a transmitted signal (x) can be effectively recovered from a received signal (y). Specifically, in the context of the following equation: y=Hx+n, n may represent a noise vector (e.g., additive white gaussian noise (AWGN)), and H may be estimated based on pilot signals or reference signals (e.g., demodulation reference signals (DMRS)). The transmitted signal (x) can them be estimated using H and decoded.

For example, a wireless node may receive signaling comprising data and a reference signal, and the wireless node may use the reference signal to estimate the channel. However, such channel estimation may be flawed due to pathloss and noise, and/or in some cases, due to the estimated channel (H) being an inaccurate representation of true channel conditions. In such scenarios, the wireless node receiving the signal may incorrectly apply phase rotations to parts of the coded bits.

It should be noted that a polar code has a unique algebraic structure (e.g., an automorphism structure) such that, if a QPSK modulated polar codeword is rotated elementwise by π or a factor of π, then the resulting signal is still a polar codeword. For examples, information bits corresponding to a rotated codeword may differ from the information bits of the original codeword by at most 1-bit. Moreover, if the last bit in u-domain of a polar code is flipped, then every bit in the x domain is also flipped. This means that, if a QPSK modulated polar codeword associated with information bits [a₀, a₁, . . . , a_{K-1}] was rotated element-wise by π, then the resulting signal is another polar codeword associated with info bits [a₀, a₁, . . . , a_{K-1}+1], where + denotes bit XOR.

Aspects of the disclosure are directed to a modified approach to polar coding that takes advantage of the aforementioned properties to reduce or eliminate phase errors associated with received signaling.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

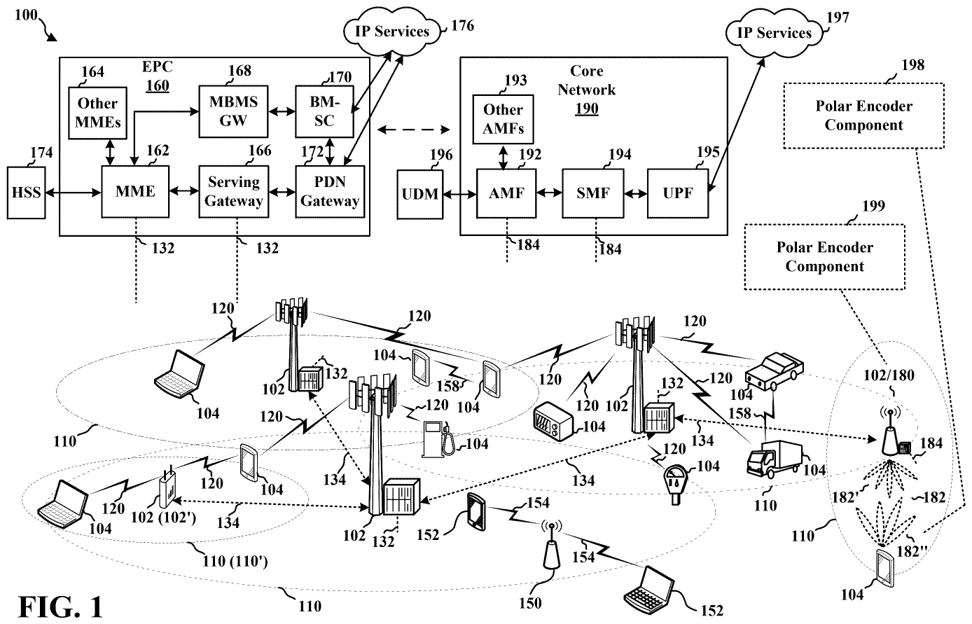

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A wireless node may comprise a UE, a base station, or a network entity.

Referring again to FIG. 1, the UE 104 may include a polar encoder component 198. As described in more detail elsewhere herein, the polar encoder component 198 may be configured to generate encoded data by using at least one of a first block of u-domain bits comprising a first u-domain bit being a frozen bit and further being indicative of a phase associated with transmission of the first block via the encoded data; and output the encoded data for transmission. Additionally, or alternatively, the polar encoder component 198 may perform one or more other operations described herein.

The base station 102/180 may include a polar encoder component 199. As described in more detail elsewhere herein, the polar encoder component may be configured to decode encoded data to obtain at least a first block of u-domain bits comprising a first u-domain bit being a first frozen bit; and measure a phase error associated with the first block based on a value of the first u-domain bit and a network-related value Additionally, or alternatively, the polar encoder component 199 may perform one or more other operations described herein.

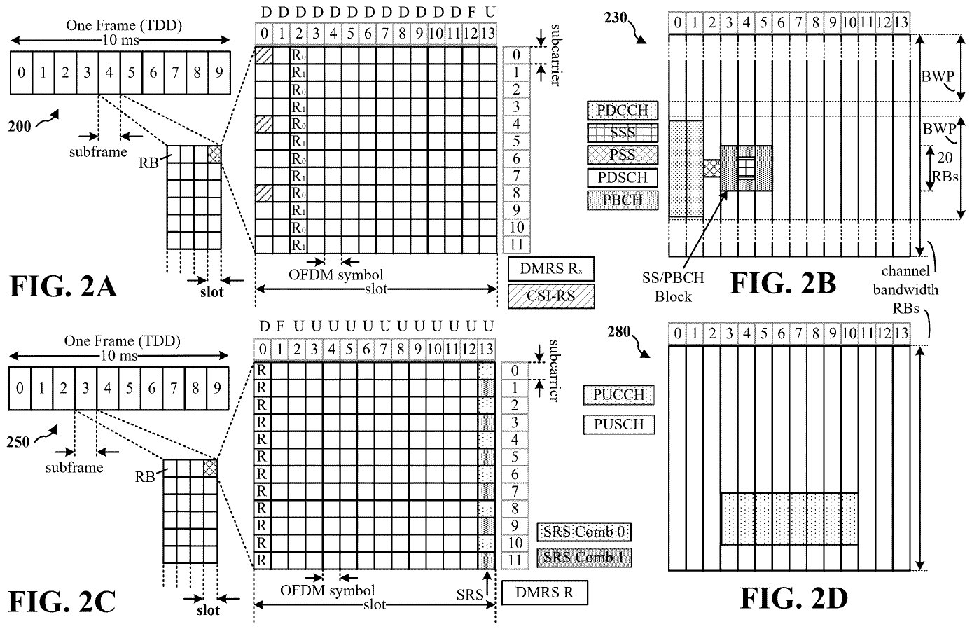

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

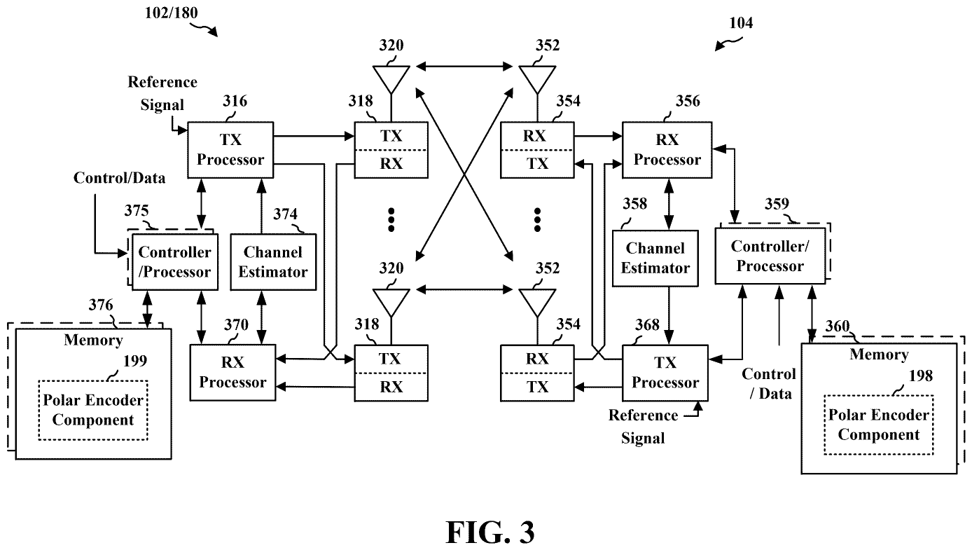

FIG. 3 is a block diagram of a base station 102/180 in communication with a UE 104 in an access network. In the DL, IP packets from the EPC 160 may be provided to one or more controller/processors 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102/180. These soft decisions may be based on channel estimates computed by the channel estimator 358. The soft decisions are then decoded and deinterleaved to recover the data and control signals that were originally transmitted by the base station 102/180 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 102/180, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102/180 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102/180 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

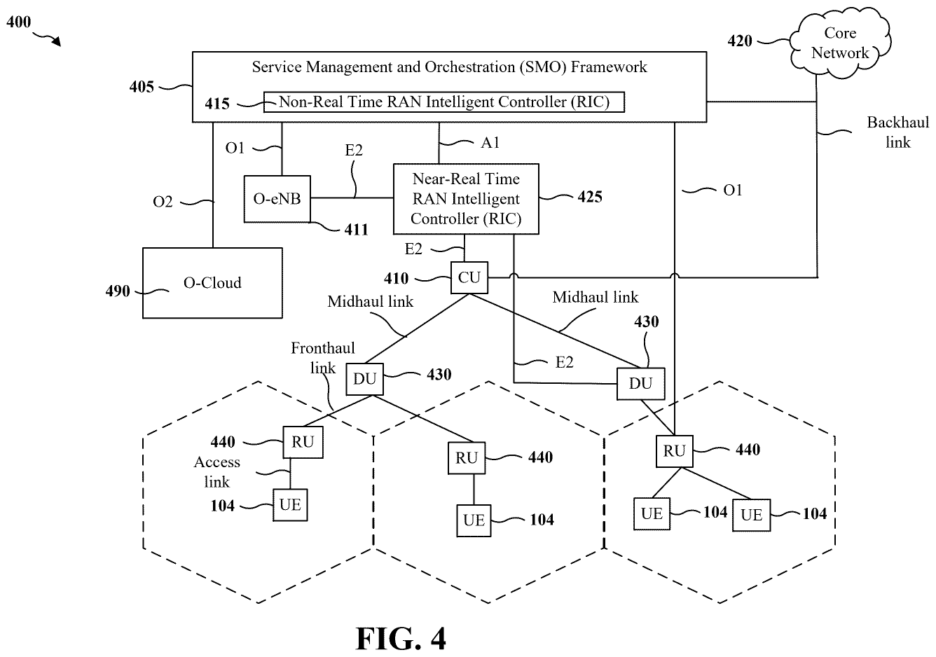

FIG. 4 is a block diagram illustrating an example disaggregated base station 400 architecture. The disaggregated base station 400 architecture may include one or more CUs 410 that can communicate directly with a core network 420 via a backhaul link, or indirectly with the core network 420 through one or more disaggregated base station units (such as a near real-time (RT) RIC 425 via an E2 link, or a non-RT RIC 415 associated with a service management and orchestration (SMO) Framework 405, or both). A CU 410 may communicate with one or more DUs 430 via respective midhaul links, such as an F1 interface. The DUs 430 may communicate with one or more RUs 440 via respective fronthaul links. The RUs 440 may communicate with respective UEs 104 via one or more radio frequency (RF) access links. In some implementations, the UE 104 may be simultaneously served by multiple RUs 440. As used herein, a network entity may correspond to a base station or to a disaggregated aspect (e.g., CU/DU/RU, etc.) of the base station.

Each of the units, i.e., the CUs 410, the DUs 430, the RUs 440, as well as the near-RT RICs 425, the non-RT RICs 415 and the SMO framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include one or more receivers, one or more transmitters or transceivers (such as one or more radio frequency (RF) transceivers), configured to receive or transmit signals, or both, over a wireless transmission medium to one or more of the other units.

In some aspects, the CU 410 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., central unit-user plane (CU-UP)), control plane functionality (i.e., central unit-control plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a virtual RAN (vRAN) architecture.

The SMO Framework 405 may be configured to support RAN deployment and provisioning of non-virtualized and virtualized network elements. For non-virtualized network elements, the SMO framework 405 may be configured to support the deployment of dedicated physical resources for RAN coverage requirements, which may be managed via an operations and maintenance interface (such as an O1 interface). For virtualized network elements, the SMO framework 405 may be configured to interact with a cloud computing platform (such as an open cloud (O-cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and near-RT RICs 425. In some implementations, the SMO framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO framework 405 also may include the non-RT RIC 415 configured to support functionality of the SMO Framework 405.

The non-RT RIC 415 may be configured to include a logical function that enables non-real-time control and optimization of RAN elements and resources, artificial intelligence/machine learning (AI/ML) workflows including model training and updates, or policy-based guidance of applications/features in the near-RT RIC 425. The non-RT RIC 415 may be coupled to or communicate with (such as via an A1 interface) the near-RT RIC 425. The near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the near-RT RIC 425.

In some implementations, to generate AI/ML models to be deployed in the near-RT RIC 425, the non-RT RIC 415 may receive parameters or external enrichment information from external servers. Such information may be utilized by the near-RT RIC 425 and may be received at the SMO Framework 405 or the non-RT RIC 415 from non-network data sources or from network functions. In some examples, the non-RT RIC 415 or the near-RT RIC 425 may be configured to tune RAN behavior or performance. For example, the non-RT RIC 415 may monitor long-term trends and patterns for performance and employ AI/ML models to perform corrective actions through the SMO Framework 405 (such as reconfiguration via 01) or via creation of RAN management policies (such as A1 policies).

### Examples of Modified Polar Coding

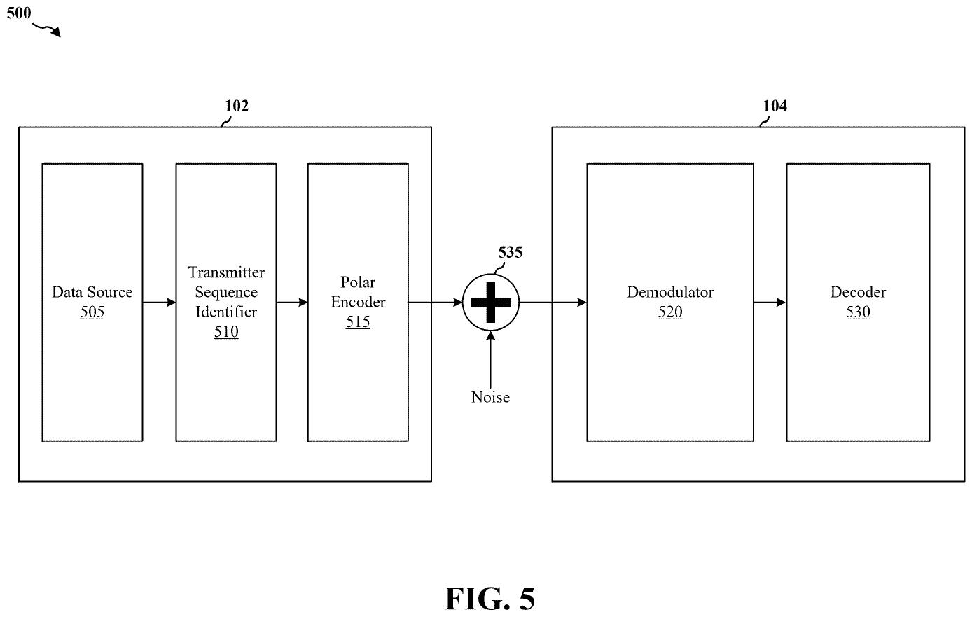

FIG. 5 illustrates an example of a wireless communications system 500 that supports modified polar coding in accordance with various aspects of the present disclosure. In some examples, the wireless communications system 500 may implement aspects of the wireless communications system and access network 100 of FIG. 1. In the example of FIG. 5, a network entity 102 may use polar encoding to encode information bits for transmission to a UE 104 via a communication channel 535. In some examples, the UE 104 may encode data for transmission to the network entity 102 or to another UE using these same techniques. In further examples, the network entity 102 may encode data for transmission to another network entity using these same techniques. Moreover, devices other than the network entity 102 and the UE 104 may use the techniques described herein for decoding a codeword encoded using a polar code.

In the depicted example, the network entity 102 may include a data source 505, a transmitter sequence identifier 510, and a polar encoder 515. The data source 505 may provide an information vector of k information bits to be encoded and transmitted to the UE 104. The data source 505 may be coupled to a network, a storage device, or the like. The data source 505 may output the information vector to the sequence identifier 510. The transmitter sequence identifier 510 may select a length N in bits of a codeword and a bit index reliability sequence corresponding to the selected length N. The transmitter sequence identifier 510 may output the k information bits, the length N, and the bit index reliability sequence to the polar encoder 515 for polar encoding. In some examples, the transmitter sequence identifier 510 identifies a quantity or number of sub-blocks (l) associated with the codeword. For example, if the polar codeword (e.g., block) has length N, that codeword may be divided into l sub-blocks. In some examples, one or more of N and/or l may be configured at both the UE 104 and the network entity 102.

In certain aspects, the transmitter sequence identifier 510 may set one or more u-domain bits within each a sub-block of bits as a frozen bit and/or a special bit. A frozen bit is a bit having a value known to both an encoder (e.g., polar encoder 515 of the network entity 102) and a decoder/demodulator (e.g., demodulator 520 and/or decoder 530 of UE 104) and, in some examples, may be set as ‘0.’ For N channels, k information bits may be loaded into the k most reliable channels and N−k frozen bits may be loaded into the N-k least reliable channels, where, in some cases, k<N. A frozen bit is treated the same at both the transmitter (e.g., the network entity 102) and the receiver (e.g., the UE 104).

The encoder may set the last information bit in each N/l-bit block in the u-domain as a special bit and refrain from using any information bits at those locations. The value of a special bit may be known to both the encoder and the decoder/demodulator and may be set to any suitable value. Thus, the location and value of special bits may be known by both the encoder of the transmitter and the decoder/demodulator of the receiver. At the transmitter side (e.g., network entity 102), special bits may be treated as frozen bits. That is, the special bits are not configured to include information bits. In some examples, the transmitter may refrain from using special bits for cyclic redundancy check (CRC) computation. In contrast, special bits may be treated as “unknown” information bits by the receiver; however, the receiver may refrain from using the special bits for CRC computation (e.g., CRC-aided list decoding). In some examples, the special bits may include any suitable value, such as any non-zero value. The decoder 530 may decode all true information bits as well as the special bits, but separate the decoded special bits from the true information bits as the payload. The decoded value of a special bit may indicate a block-level phase-π error associated with a corresponding block that carried the special bit. If a phase error associated with a particular sub-block is detected, then the discrete value of the phase error may be returned to the decoder 530 and used to update a channel estimation or channel quality measurement procedure.

Polar coding is characterized by an algebraic/automorphic structure such that, if a modulated (e.g., QPSK, BPSK, etc.) polar codeword is rotated elementwise by π, then the resulting signal is still a polar codeword. In particular, the information bits corresponding to the rotated codeword may differ from the information bits of the original codeword by at most 1-bit. Moreover, if the last u-domain bit used in a polar code is flipped, then every bit in the codeword (e.g., x-domain) is also flipped. Thus, if a modulated polar codeword associated with information bits [a_0, a_1, . . . , a_(k−1)] was rotated element-wise by T, then the resulting signal is another polar codeword associated with information bits [a_0, a_1, . . . , a_(k−1)+1], where + indicated bit XOR. As such, by setting the last information bit in each N/l-bit block in the u-domain as a special bit having a known location and value, the decoder 530 can detect phase rotation if the special bit is received in a location different from the known location. Accordingly, the special bits may function as a mask to a codeword that the receiver may be used to detect block-level phase errors that are multiples of π. It should further be noted that the phase error may be between 0 and 2π.

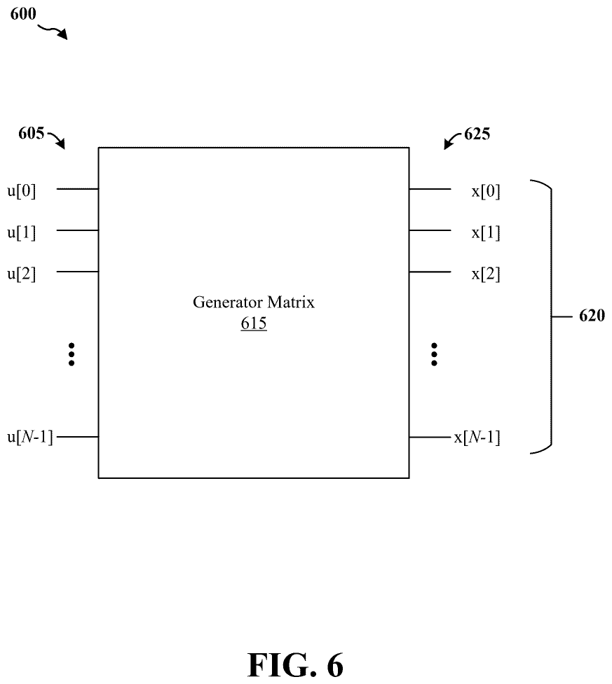

The polar encoder 515 may generate a codeword of length N based on the set of k information bits received from the data source 505. With reference to FIG. 6, the k information bits may be loaded into channels determined from a bit-index reliability sequence, and the encoder may apply a generator matrix 615 to the input information bits, special bits, and/or frozen bits (e.g., channels u[0:N−1] 605) in order to output a codeword 620. The polar encoder 515 may pass the encoded bits of the codeword 620 to a rate-matcher (not shown) to rate-match the encoded bits to a set of resources for the transmission to the receiving device (e.g., the UE 104).

When rate-matching is employed, a subset of the N bits may be transmitted or a subset of the N bits may be repeated in the transmission. In some examples, the transmitter may refrain from puncturing or shortening the special bits of a block/sub-block for a time period (e.g., 5 ms). That is, when performing rate matching, the transmitter may be configured to ensure that the last bit in each N/l sub-block is not punctured or shortened. The rate-matcher may then input the rate-matched bits to a modulator (not shown) for modulation prior to the transmission (e.g., to UE 104). The transmitting device (e.g., network entity 102) may then transmit the rate-matched codeword to the receiving device (e.g., UE 104) over communication channel 535.

FIG. 6 illustrates an example of diagram 600 of a polar code that supports special bit distribution in accordance with various aspects of the present disclosure. In some examples, diagram 600 may implement aspects of the wireless communications system and access network 100 of FIG. 1.

The diagram 600 depicts a polar code that includes N channels for generating a polar-encoded codeword 620 with channel 0 illustrated on top, followed by channel 1, and proceeding sequentially to channel N−1. Channels u[0:N−1] 605 may represent u-domain bits to be encoded and codeword channels x[0:N−1] 625 may represent the bits once they are encoded. A generator matrix 615 may be used (e.g., by multiplying the generator matrix 615 by channels u[0:N−1] 605) by an encoder to encode information bits input to the channels u[0:N−1] 605 to generate codeword channels x[0:N−1] 625, and may be used (e.g., by multiplying codeword channels x[0:N−1] 625 by the inversion of the generator matrix 615 or by another matrix derived from the generator matrix 615) by a decoder (e.g., decoder 530) to decode information received on codeword channels x[0:N−1] 625 to obtain a representation of the information bits, special bits, and frozen bits on channels u[0:N−1] 605. The location of any particular channel may depend on its reliability relative to other channels of the polar code.

As discussed, the transmitting device may set the last bit in each N/l sub-block to a value known by both the transmitting device and the receiving device. Using the example illustrated in FIG. 6, if the u-domain channels are defined as u[0:7] (e.g., N=8), and l=2, then the transmitting device may divide the u-domain channels into two sub-blocks (e.g., a first sub-block u[0]-u[3], and a second sub-block u[4]-u[7]), and set the last bit (e.g., u[3] and u−[7]) in each sub-block to a special bit value.

In some examples, PDCCH may be transmitted in units known as control channel elements (CCEs), where, for example, 1 CCE includes 6 RBs. Channel estimation may be performed by a receiving device within one CCE, or within multiples of CCEs. Accordingly, the transmitting device may be configured to align the sub-block size (e.g., N/l) with a size of a precoding resource block group (PRG) on PDCCH such that the receiving device is able to detect (e.g., based on the location of the special bits) relatively constant phase errors within each sub-block. In some examples, the transmitting device may reserve 2-bits to be used as special bits in each subblock.

In some examples, PUCCH may be scheduled with frequency hopping. Because channel estimation errors may be similar within each frequency hop, the number of subblocks (l) may be set to be equivalent to a quantity of frequency hops. Accordingly, the transmitting device (e.g., UE 104) may reserve 1-bit in each frequency hop to be used as a special bit.

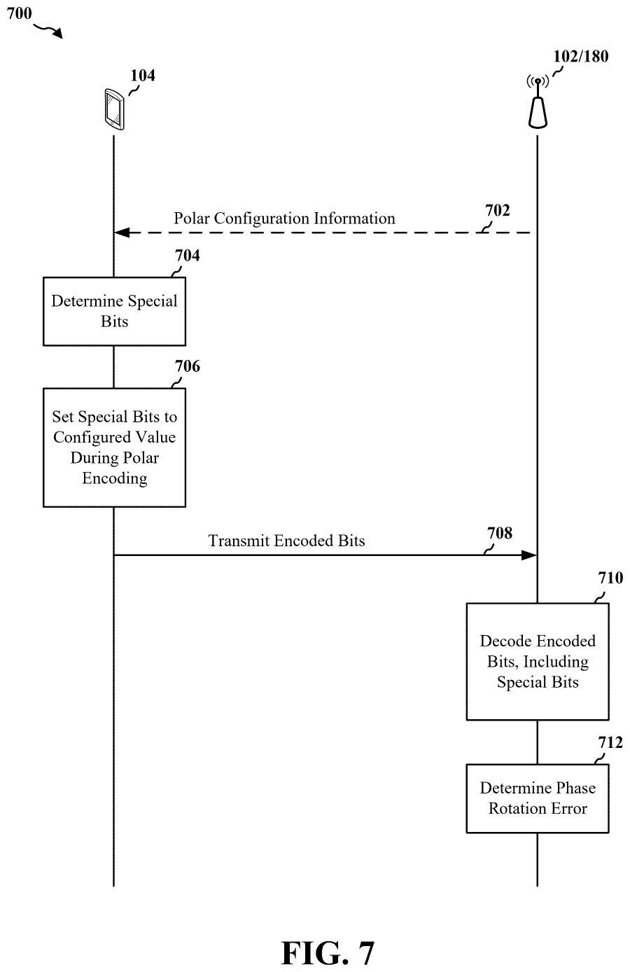

FIG. 7 is a call-flow diagram illustrating example communications 700 between a transmitting device (e.g., UE 104) and a receiving device (e.g., network entity 102). In some examples, the illustrated communications 700 include the techniques described in FIGS. 5 and 6 and may be implemented in the wireless communications system and access network 100 of FIG. 1.

At a first optional communication 702, the network entity 102 may transmit polar coding information to the UE 104. The polar coding information may include an indication of one or more of: a number of sub-blocks (l), a polar codeword length (N), and/or one or more special bit values to be used for transmission and reception of data.

The UE 104 may determine to transmit data to the network entity 102. Prior to transmission of the data, the UE 104, at a first process 704, may determine which u-domain bits to use as special bits. For example, the UE 104 may determine to use the last bit of each sub-block as a special bit. At a second process 706, the UE 104 may then set the last u-domain bits of each sub-block (e.g., the special bits) to a value known by both the UE 104 and the network entity 102. The UE 104 may then polar encode the u-domain bits to generate x-domain bits.

At a second communication 708, the UE 104 may transmit the encoded bits to the network entity 102. The network entity 102 may receive and demodulate the encoded bits received in the second communication 708. At a third process 710, the network entity 102 may decode the encoded bits, including the special bits. Note that the special bits may be treated as information bits by the network entity 102, hence they may be decoded in contrast with frozen bits, which the network entity 102 may refrain from decoding.

At a fourth process 712, the network entity 102 may determine, based on the special bits, whether a phase rotation error is associated with the decoded bits. If a phase rotation error is detected, the network entity 102 may either: do nothing, or determine the phase rotation error (e.g., π/2) and update its channel estimation processing to correct channel estimation and reduce or eliminate the phase rotation error in future transmissions it receives and decodes.

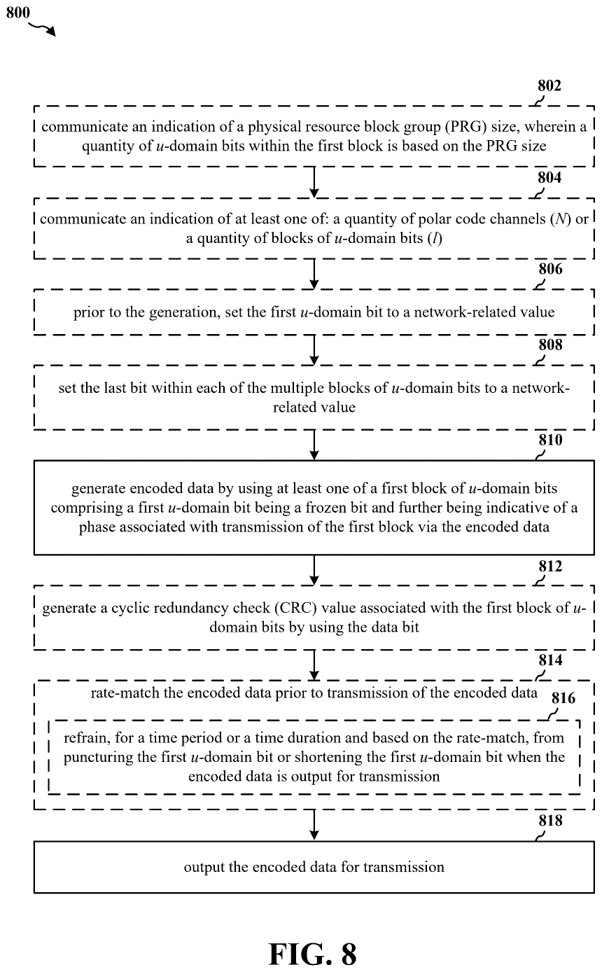

FIG. 8 is a flowchart 800 of a method of wireless communication. The method may be performed by a UE or a network entity (e.g., the UE 104; network entity 102; the apparatus 902). Specifically, the method may be performed by one or more memories, processors, and RF front ends (e.g., the memory 360/376, controller/processor 359/375, transmitter 354TX/318TX, receiver 354RX/318RX, antenna 352/320, etc. of FIG. 3).

At 802, the UE or a network entity may optionally communicate an indication of a physical resource block group (PRG) size, wherein a quantity of u-domain bits within the first block is based on the PRG size. For example, 802 may be performed by a communicating component 940. Here, the UE or the network entity may transmit, or receive, signaling configured to indicate a PRG size so that the other device can align the subblock size with the PRG size for polar encoding. As discussed, PDCCH may be transmitted in units of CCEs, and channel estimation may be performed within one CCE, or within multiples of CCEs. In some examples, the subblock size (e.g., N/l) may be aligned with a PRG (precoding RB group) on PDCCH, such that the receiving device sees relatively constant phase errors within each subblock.

At 804, the UE or a network entity may optionally communicate an indication of at least one of: a quantity of polar code channels (N) or a quantity of blocks of u-domain bits (l). For example, 804 may be performed by the communicating component 940. Here, the UE or the network entity may transmit, or receive, signaling configured to indicate one or more of the N or l values so that it can determine a subblock size.

At 806, the UE or a network entity may optionally prior to the generation, set the first u-domain bit to a network-related value. For example, 806 may be performed by a setting component 942. Here, in some examples, the UE or the network entity may set a last bit in each subblock to a network configured value (e.g., all 1's or all 0's) so that the receiving device can determine whether the signaling it received was correctly rotated.

At 808, the UE or a network entity may optionally set the last bit within each of the multiple blocks of u-domain bits to a network-related value. For example, 808 may be performed by the setting component 942. As discussed above, the UE or the network entity may set a last bit in each subblock to a network configured value so that the receiving device can determine whether the signaling it received was correctly rotated.

At 810, the UE or a network entity may generate encoded data by using at least one of a first block of u-domain bits comprising a first u-domain bit being a frozen bit and further being indicative of a phase associated with transmission of the first block via the encoded data. For example, 810 may be performed by a generating component 944. Here, the UE or network entity may set a bit of the block of bits to a value known to both the UE and the network entity. This set bit is a special bit but may be treated like a frozen bit by the transmitter and may be configured to indicate a phase associated with the block of bits. The receiving device may treat the special bit as an information bit (e.g., instead of a frozen bit).

At 812, the UE or a network entity may optionally generate a cyclic redundancy check (CRC) value associated with the first block of u-domain bits by using the data bit. For example, 812 may be performed by the generating component 944. Here, because the transmitter treats the special bit as a frozen bit, the special bit does not include information bits and it will not be part of a CRC computation.

At 814, the UE or a network entity may optionally rate-match the encoded data prior to transmission of the encoded data. For example, 814 may be performed by rate-matching component 946.

At 816, the UE or a network entity may optionally refrain, for a time period and based on the rate-match, from puncturing the first u-domain bit or shortening the first u-domain bit when the encoded data is output for transmission. For example, 816 may be performed by the rate-matching component 946. Here, the transmitter may ensure that the last bit in each N/l-length subblock is not punctured or shortened. This way, the special bit(s) is preserved. In some examples, the time period may be any suitable amount of time (e.g., 5 ms).

At 818, the UE or a network entity may output the encoded data for transmission. For example, 818 may be performed by the communicating component 940.

In certain aspects, the first u-domain bit is a last u-domain bit within the first block of u-domain bits.

In certain aspects, the encoded data is modulated via quadrature phase shift keying (QPSK), binary phase shift keying (BPSK), or π/2 BPSK.

In certain aspects, the encoded data is generated by using multiple blocks of u-domain bits including the first block of u-domain bits, wherein a last bit within each of the multiple blocks of u-domain bits is a frozen bit and indicates a phase associated with transmission of a corresponding block of the multiple blocks of u-domain bits.

In certain aspects, a quantity of blocks associated with the multiple blocks is a power of 2.

In certain aspects, each of the multiple blocks of u-domain bits is associated with one of multiple control channel elements (CCEs).

In certain aspects, the first block of u-domain bits further comprises a second u-domain bit being a data bit.

In certain aspects, the generation of the CRC value comprises omitting the frozen bit.

In certain aspects, the quantity of blocks of u-domain bits (l) is a function of a quantity of frequency hops associated with the transmission of the encoded data.

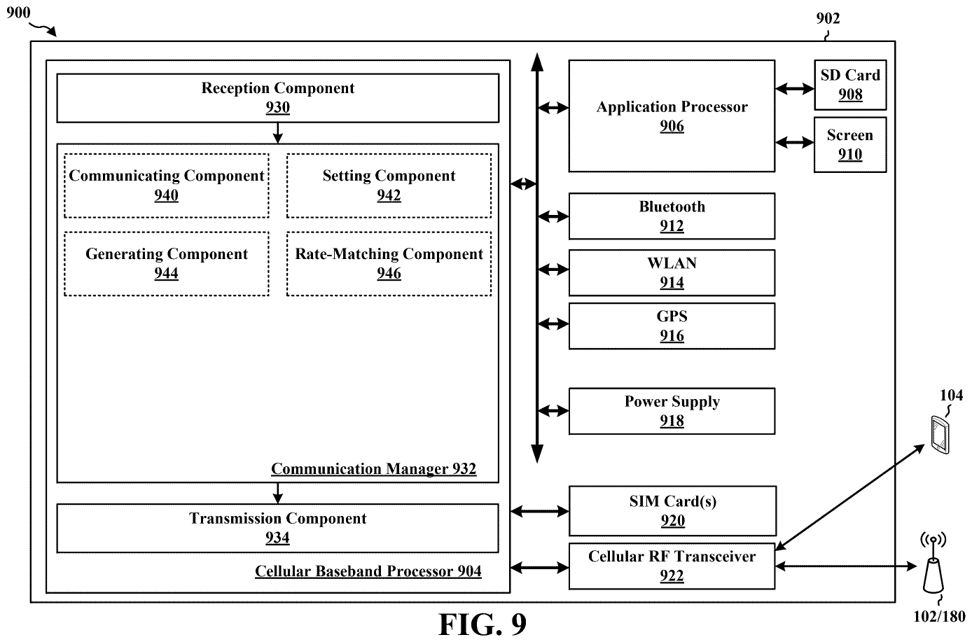

FIG. 9 is a diagram 900 illustrating an example of a hardware implementation for an apparatus 902. The apparatus 902 may be implemented as a UE or a network entity and includes a cellular baseband processor 904 (also referred to as a modem) coupled to one or more cellular RF transceivers 922 and one or more subscriber identity modules (SIM) cards 920, an application processor 906 coupled to a secure digital (SD) card 908 and a screen 910, a Bluetooth module 912, a wireless local area network (WLAN) module 914, a Global Positioning System (GPS) module 916, and a power supply 918. The cellular baseband processor 904 communicates through the one or more cellular RF transceivers 922 with the UE 104 and/or BS 102/180. The cellular baseband processor 904 may include a computer-readable medium/memory. The computer-readable medium/memory may be non-transitory. The cellular baseband processor 904 is responsible for general processing, including the execution of software stored on the computer-readable medium/memory. The software, when executed by the cellular baseband processor 904, causes the cellular baseband processor 904 to perform the various functions described supra. The computer-readable medium/memory may also be used for storing data that is manipulated by the cellular baseband processor 904 when executing software. The cellular baseband processor 904 further includes a reception component 930, a communication manager 932, and a transmission component 934. The communication manager 932 includes the one or more illustrated components. The components within the communication manager 932 may be stored in the computer-readable medium/memory and/or configured as hardware within the cellular baseband processor 904. The cellular baseband processor 904 may be a component of the UE 104 and may include the memory 360 and/or at least one of the TX processor 368, the RX processor 356, and the controller/processor 359. In one configuration, the apparatus 902 may be a modem chip and include just the baseband processor 904, and in another configuration, the apparatus 902 may be the entire UE (e.g., see UE 104 of FIG. 3) and include the aforediscussed additional modules of the apparatus 902.

In various examples, the apparatus 902 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 932 includes a communicating component 940 that is configured to transmit (e.g., output for transmission) or receive (e.g., obtain) wireless signals. For example, the communicating component 940 may be configured to: communicate an indication of a physical resource block group (PRG) size, wherein a quantity of u-domain bits within the first block is based on the PRG size; communicate an indication of at least one of: a quantity of polar code channels (N) or a quantity of blocks of u-domain bits (l); and output the encoded data for transmission; e.g., as described in connection with 802, 804, and 818.

The communication manager 932 further includes a setting component 942 configured to: prior to the generation, set the first u-domain bit to a network-related value; and set the last bit within each of the multiple blocks of u-domain bits to a network-related value; e.g., as described in connection with 806 and 808.

The communication manager 932 further includes a generating component 944 configured to: generate encoded data by using at least one of a first block of u-domain bits comprising a first u-domain bit being a frozen bit and further being indicative of a phase associated with transmission of the first block via the encoded data; and generate a cyclic redundancy check (CRC) value associated with the first block of u-domain bits by using the data bit; e.g., as described in connection with 810 and 812.

The communication manager 932 further includes a rate-matching component 946 configured to: rate-match the encoded data prior to transmission of the encoded data; and refrain, for a time period and based on the rate-match, from puncturing the first u-domain bit or shortening the first u-domain bit when the encoded data is output for transmission; e.g., as described in connection with 814 and 816.

The apparatus may include additional components that perform each of the blocks of the algorithm in the aforementioned flowchart of FIG. 8. As such, each block in FIG. 8 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 902, and in particular the cellular baseband processor 904, includes: means for communicating an indication of a physical resource block group (PRG) size, wherein a quantity of u-domain bits within the first block is based on the PRG size; means for communicating an indication of at least one of: a quantity of polar code channels (N) or a quantity of blocks of u-domain bits (l); means for, prior to the generation, setting the first u-domain bit to a network-related value; means for setting the last bit within each of the multiple blocks of u-domain bits to a network-related value; means for generating encoded data by using at least one of a first block of u-domain bits comprising a first u-domain bit being a frozen bit and further being indicative of a phase associated with transmission of the first block via the encoded data; means for generating a cyclic redundancy check (CRC) value associated with the first block of u-domain bits by using the data bit; means for rate-matching the encoded data prior to transmission of the encoded data; means for refraining, for a time period and based on the rate-match, from puncturing the first u-domain bit or shortening the first u-domain bit when the encoded data is output for transmission; and means for outputting the encoded data for transmission.

The aforementioned means may be one or more of the aforementioned components of the apparatus 902 configured to perform the functions recited by the aforementioned means. As described supra, the apparatus 902 may include the TX Processor 368/316, the RX Processor 356/370, and the one or more controller/processor(s) 359/375. As such, in one configuration, the aforementioned means may be the TX Processor 368/316, the RX Processor 356/370, and the controller/processor(s) 359/375 configured to perform the functions recited by the aforementioned means.

Means for communications, means for receiving, or means for obtaining may include a receiver (such as the receive processor 356/370) and/or an antenna(s) 320/352 of the network entity 102/180 or the UE 104 illustrated in FIG. 3. Means for communicating, means for transmitting, or means for outputting may include a transmitter (such as the transmit processor 316/368) or an antenna(s) 320/352 of the network entity 102/180 or the UE 104 illustrated in FIG. 3. Means for generating, means for setting, means for refraining from puncturing, and means for rate-matching may include a processing system, which may include one or more processors, such as the controller/processor(s) 359/370, one or more memories 360/376, and/or any other suitable hardware components of the network entity 102/180 and UE 104 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

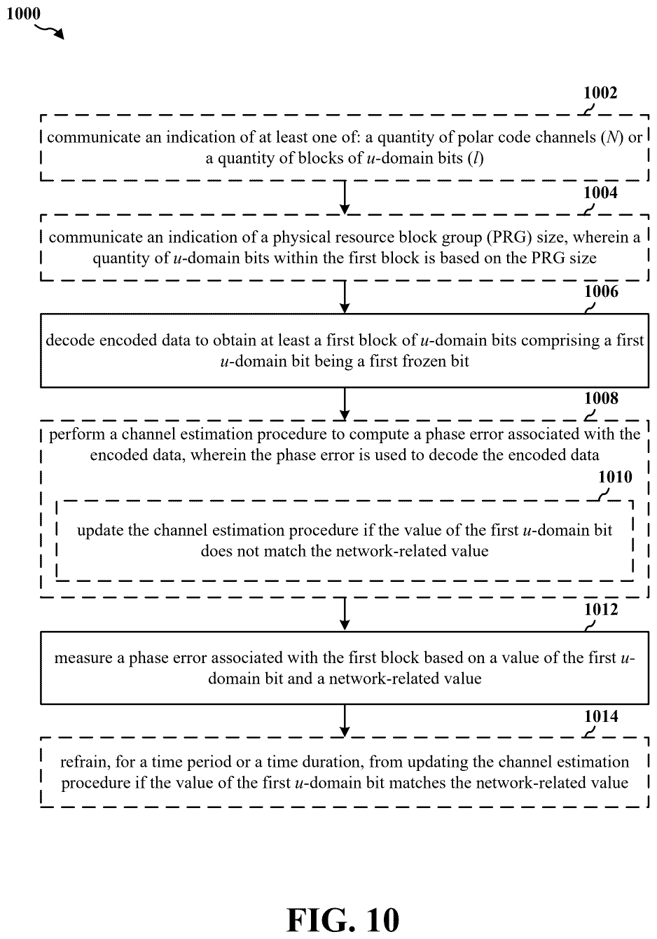

FIG. 10 is a flowchart 1000 of a method of wireless communication. The method may be performed by a UE or a network entity (e.g., the UE 104; network entity 102; the apparatus 1102). Specifically, the method may be performed by one or more memories, processors, and RF front ends (e.g., the memory 360/376, controller/processor 359/375, transmitter 354TX/318TX, receiver 354RX/318RX, antenna 352/320, etc. of FIG. 3).

At 1002, the UE or a network entity may optionally communicate an indication of at least one of: a quantity of polar code channels (N) or a quantity of blocks of u-domain bits (l). For example, 1002 may be performed by a communicating component 1140. Here, the UE or the network entity may communicate (e.g., transmit to the other device or receive from the other device) an indication of a size of a subblock.

At 1004, the UE or a network entity may optionally communicate an indication of a physical resource block group (PRG) size, wherein a quantity of u-domain bits within the first block is based on the PRG size. For example, 1004 may be performed by the communicating component 1140.

At 1006, the UE or a network entity may decode encoded data to obtain at least a first block of u-domain bits comprising a first u-domain bit being a first frozen bit. For example, 1006 may be performed by a decoding component 1142. Here, the UE or the network entity may receive encoded data, and may then proceed to decode the encoded data.

At 1008, the UE or a network entity may optionally perform a channel estimation procedure to compute a phase error associated with the encoded data, wherein the phase error is used to decode the encoded data. For example, 1008 may be performed by a channel estimation component 1144. Here, the UE or the network entity may perform channel estimation and use the estimation to decode the encoded data.

At 1010, the UE or a network entity may optionally update the channel estimation procedure if the value of the first u-domain bit does not match the network-related value. For example, 1010 may be performed by an updating component 1146. Here, the UE or the network entity may update its channel estimation algorithm if channel estimation resulted in an erroneous phase rotation during decoding/demodulation.

At 1012, the UE or a network entity may measure a phase error associated with the first block based on a value of the first u-domain bit and a network-related value. For example, 1012 may be performed by a measuring component 1148.

At 1014, the UE or a network entity may optionally refrain, for a time period, from updating the channel estimation procedure if the value of the first u-domain bit matches the network-related value. For example, 1014 may be performed by the channel estimating component 1144. In some examples, the time period may be any suitable amount of time (e.g., 5 ms).

In certain aspects, the first u-domain bit is a last u-domain bit within the first block of u-domain bits.

In certain aspects, the encoded data is decoded via quadrature phase shift keying (QPSK), binary phase shift keying (BPSK), or π/2 BPSK.

In certain aspects, a mismatch between the first u-domain bit and the network-related value is indicative of a phase error of the first block, wherein the phase error is a function of π.

In certain aspects, the encoded data is decoded to further determine multiple blocks of u-domain bits including the first block, wherein a last bit within each of the multiple blocks of u-domain is a frozen bit and indicates a phase associated with transmission of a corresponding block of the multiple blocks of u-domain bits.

In certain aspects, each of the multiple blocks of u-domain bits is associated with one of multiple control channel elements (CCEs).

In certain aspects, the quantity of blocks of u-domain bits (l) is a function of a quantity of frequency hops associated with obtaining the encoded data.

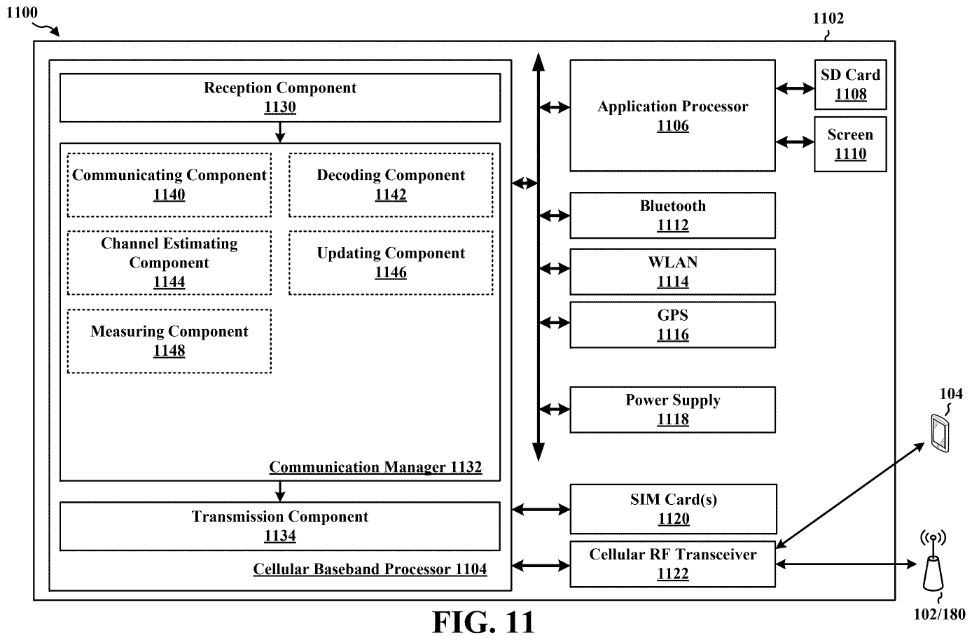

FIG. 11 is a diagram 1100 illustrating an example of a hardware implementation for an apparatus 1102. The apparatus 1102 may be implemented as a BS or a UE, and includes a baseband unit 1104. The baseband unit 1104 may communicate through one or more cellular RF transceivers with the UE 104. The baseband unit 1104 may include a computer-readable medium/memory. The baseband unit 1104 is responsible for general processing, including the execution of software stored on the computer-readable medium/memory. The software, when executed by the baseband unit 1104, causes the baseband unit 1104 to perform the various functions described supra. The computer-readable medium/memory may also be used for storing data that is manipulated by the baseband unit 1104 when executing software. The baseband unit 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the baseband unit 1104. The baseband unit 1104 may be a component of the BS 102/180 and may include the memory 376 and/or at least one of the TX processor 316, the RX processor 370, and the controller/processor 375.

In various examples, the apparatus 1102 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1132 includes a communicating component 1140 configured to: communicate an indication of at least one of: a quantity of polar code channels (N) or a quantity of blocks of u-domain bits (l); and communicate an indication of a physical resource block group (PRG) size, wherein a quantity of u-domain bits within the first block is based on the PRG size; e.g., as described in connection with 1002 and 1004.

The communication manager 1132 further includes a decoding component 1142 configured to: decode encoded data to obtain at least a first block of u-domain bits comprising a first u-domain bit being a first frozen bit, e.g., as described in connection with 1006.

The communication manager 1132 further includes a channel estimating component 1144 configured to: perform a channel estimation procedure to compute a phase error associated with the encoded data, wherein the phase error is used to decode the encoded data; and refrain, for a time period, from updating the channel estimation procedure if the value of the first u-domain bit matches the network-related value; e.g., as described in connection with 1008 and 1014.

The communication manager 1132 further includes an updating component 1146 configured to: update the channel estimation procedure if the value of the first u-domain bit does not match the network-related value; e.g., as described in connection with 1010.

The communication manager 1132 further includes a measuring component 1148 configured to: measure a phase error associated with the first block based on a value of the first u-domain bit and a network-related value; e.g., as described in connection with 1012.

The apparatus may include additional components that perform each of the blocks of the algorithm in the aforementioned flowchart of FIG. 10. As such, each block in FIG. 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1102, and in particular the baseband unit 1104, includes: means for communicating an indication of at least one of: a quantity of polar code channels (N) or a quantity of blocks of u-domain bits (l); means for communicating an indication of a physical resource block group (PRG) size, wherein a quantity of u-domain bits within the first block is based on the PRG size; means for decoding encoded data to obtain at least a first block of u-domain bits comprising a first u-domain bit being a first frozen bit; means for performing a channel estimation procedure to compute a phase error associated with the encoded data, wherein the phase error is used to decode the encoded data; means for updating the channel estimation procedure if the value of the first u-domain bit does not match the network-related value; means for measuring a phase error associated with the first block based on a value of the first u-domain bit and a network-related value; and means for refraining, for a time period, from updating the channel estimation procedure if the value of the first u-domain bit matches the network-related value.

The aforementioned means may be one or more of the aforementioned components of the apparatus 1102 configured to perform the functions recited by the aforementioned means. As described supra, the apparatus 1102 may include the TX Processor 316/368, the RX Processor 356/370, and the controller/processor(s) 359/375. As such, in one configuration, the aforementioned means may be the TX Processor 316/368, the RX Processor 356/370, and the controller/processor(s) 359/375 configured to perform the functions recited by the aforementioned means.

Means for communicating, means for receiving, or means for obtaining may include a receiver, such as the receive processor 356/370 and/or antenna(s) 320/352 of the network entity 102/180 and UE 104 illustrated in FIG. 3. Means for communicating, means for transmitting, or means for outputting may include a transmitter such as the transmit processor 316/368 or antenna(s) 320/352 of the network entity 102/180 and UE 104 illustrated in FIG. 3. Means for decoding, means for encoding, means for updating, means for channel estimation, means for measuring, means for refraining, and means for determining may include a processing system, which may include one or more processors, such as the controller/processor 359/375, one or more memories 360/376, and/or any other suitable hardware components of the network entity 102/180 and UE 104 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

### ADDITIONAL CONSIDERATIONS

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### EXAMPLE ASPECTS

The following examples are illustrative only and may be combined with aspects of other embodiments or teachings described herein, without limitation.

A method for wireless communication at a wireless node, comprising: generating encoded data by using at least one of a first block of u-domain bits comprising a first u-domain bit being a frozen bit and further being indicative of a phase associated with transmission of the first block via the encoded data; and outputting the encoded data for transmission.

Example 2 is the method of Example 1, wherein the first u-domain bit is a last u-domain bit within the first block of u-domain bits.

Example 3 is the method of any of Examples 1 and 2, wherein the encoded data is modulated via quadrature phase shift keying (QPSK), binary phase shift keying (BPSK), or π/2 BPSK.

Example 4 is the method of any of Examples 1-3, further comprising: prior to the generation, setting the first u-domain bit to a network-related value.

Example 5 is the method of any of Examples 1-4, wherein the encoded data is generated by using multiple blocks of u-domain bits including the first block of u-domain bits, wherein a last bit within each of the multiple blocks of u-domain bits is a frozen bit and indicates a phase associated with transmission of a corresponding block of the multiple blocks of u-domain bits.

Example 6 is the method of Example 5, wherein a quantity of blocks associated with the multiple blocks is a power of 2.

Example 7 is the method of any of Examples 5 and 6, further comprising: setting the last bit within each of the multiple blocks of u-domain bits to a network-related value. Example 8 is the method of any of Examples 5-7, wherein each of the multiple blocks [0161] of u-domain bits is associated with one of multiple control channel elements (CCEs).

Example 9 is the method of any of Examples 1-8, wherein the first block of u-domain bits further comprises a second u-domain bit being a data bit, and wherein the method further comprises: generating a cyclic redundancy check (CRC) value associated with the first block of u-domain bits by using the data bit.

Example 10 is the method of Example 9, wherein the generation of the CRC value comprises omitting the frozen bit.

Example 11 is the method of any of Examples 1-10, further comprising: communicating an indication of at least one of: a quantity of polar code channels (N) or a quantity of blocks of u-domain bits (l).

Example 12 is the method of Example 11, wherein the quantity of blocks of u-domain bits (l) is a function of a quantity of frequency hops associated with the transmission of the encoded data.

Example 13 is the method of any of Examples 1-12, further comprising: communicating an indication of a physical resource block group (PRG) size, wherein a quantity of u-domain bits within the first block is based on the PRG size.

Example 14 is the method of any of Examples 1-13, further comprising: rate-matching the encoded data prior to transmission of the encoded data; and refraining, for a time period and based on the rate-match, from puncturing the first u-domain bit or shortening the first u-domain bit when the encoded data is output for transmission.

Example 15 is a method for wireless communication at a wireless entity, comprising: decoding encoded data to obtain at least a first block of u-domain bits comprising a first u-domain bit being a first frozen bit; and measuring a phase error associated with the first block based on a value of the first u-domain bit and a network-related value.

Example 16 is the method of Example 15, wherein the first u-domain bit is a last u-domain bit within the first block of u-domain bits.

Example 17 is the method of any of Examples 15 and 16, wherein the encoded data is decoded via quadrature phase shift keying (QPSK), binary phase shift keying (BPSK), or π/2 BPSK.

Example 18 is the method of any of Examples 15-17, further comprising: performing a channel estimation procedure to compute a phase error associated with the encoded data, wherein the phase error is used to decode the encoded data; and updating the channel estimation procedure if the value of the first u-domain bit does not match the network-related value.

Example 19 is the method of Example 18, further comprising: refraining, for a time period, from updating the channel estimation procedure if the value of the first u-domain bit matches the network-related value.

Example 20 is the method of any of Examples 18 and 19, wherein a mismatch between the first u-domain bit and the network-related value is indicative of a phase error of the first block, wherein the phase error is a function of π.

Example 21 is the method of any of Examples 15-20, wherein the encoded data is decoded to further determine multiple blocks of u-domain bits including the first block, wherein a last bit within each of the multiple blocks of u-domain is a frozen bit and indicates a phase associated with transmission of a corresponding block of the multiple blocks of u-domain bits.

Example 22 is the method of Example 21, wherein each of the multiple blocks of u-domain bits is associated with one of multiple control channel elements (CCEs).

Example 23 is the method of any of Examples 15-22, further comprising: communicating an indication of at least one of: a quantity of polar code channels (N) or a quantity of blocks of u-domain bits (l).

Example 24 is the method of Example 23, wherein the quantity of blocks of u-domain bits (l) is a function of a quantity of frequency hops associated with obtaining the encoded data.

Example 25 is the method of any of Examples 15-24, further comprising: communicating an indication of a physical resource block group (PRG) size, wherein a quantity of u-domain bits within the first block is based on the PRG size.

Example 26 is an apparatus for wireless communications, comprising means for performing a method in accordance with any one of examples 1-15.

Example 27 is an apparatus for wireless communications, comprising means for performing a method in accordance with any one of examples 16-25.

Example 28 is a non-transitory computer-readable medium comprising instructions that, when executed by a wireless node, cause the wireless node to perform a method in accordance with any one of examples 1-15.

Example 29 is a non-transitory computer-readable medium comprising instructions that, when executed by a wireless node, cause the wireless node to perform a method in accordance with any one of examples 16-25.

Example 30 is an apparatus for wireless communications, comprising: one or more memories, individually or in combination, having instructions; and one or more processors, individually or in combination, configured to execute the instructions and cause the apparatus to perform a method in accordance with any one of examples 1-15.

Example 31 is an apparatus for wireless communications, comprising: one or more memories, individually or in combination, having instructions; and one or more processors, individually or in combination, configured to execute the instructions and cause the apparatus to perform a method in accordance with any one of examples 16-25.

Example 32 is a wireless node (e.g., a user equipment (UE) or a network entity), comprising: one or more transceivers; one or more memories, individually or in combination, having instructions; and one or more processors, individually or in combination, configured to execute the instructions and cause the wireless node to perform a method in accordance with any one of examples 1-15, wherein the one or more transceivers are configured to: transmit the encoded data.

Example 33 is a wireless node (e.g., a user equipment (UE) or a network entity), comprising: one or more transceivers; one or more memories, individually or in combination, having instructions; and one or more processors, individually or in combination, configured to execute the instructions and cause the wireless node to perform a method in accordance with any one of examples 16-25, wherein the one or more transceivers are configured to: receive the encoded data.

What is claimed is:

1. An apparatus for wireless communication, comprising:
one or more memories, individually or in combination, having instructions; and
one or more processors, individually or in combination, configured to execute the instructions and cause the apparatus to:
generate encoded data by using at least one of a first block of u-domain bits comprising a first u-domain bit being a frozen bit and further being indicative of a phase associated with transmission of the first block via the encoded data; and
output the encoded data for transmission.

2. The apparatus of claim 1, wherein the first u-domain bit is a last u-domain bit within the first block of u-domain bits.

3. The apparatus of claim 1, wherein the encoded data is modulated via quadrature phase shift keying (QPSK), binary phase shift keying (BPSK), or π/2 BPSK.

4. The apparatus of claim 1, wherein the one or more processors, individually or in combination, are further configured to:
prior to the generation, set the first u-domain bit to a network-related value.

5. The apparatus of claim 1, wherein the encoded data is generated by using multiple blocks of u-domain bits including the first block of u-domain bits, wherein a last bit within each of the multiple blocks of u-domain bits is a frozen bit and indicates a phase associated with transmission of a corresponding block of the multiple blocks of u-domain bits.

6. The apparatus of claim 5, wherein a quantity of blocks associated with the multiple blocks is a power of 2.

7. The apparatus of claim 5, wherein the one or more processors, individually or in combination, are further configured to:
set the last bit within each of the multiple blocks of u-domain bits to a network-related value.

8. The apparatus of claim 5, wherein each of the multiple blocks of u-domain bits is associated with one of multiple control channel elements (CCEs).

9. The apparatus of claim 1, wherein the first block of u-domain bits further comprises a second u-domain bit being a data bit, and wherein the one or more processors, individually or in combination, are further configured to:
generate a cyclic redundancy check (CRC) value associated with the first block of u-domain bits by using the data bit.

10. The apparatus of claim 9, wherein the generation of the CRC value comprises omitting the frozen bit.

11. The apparatus of claim 1, wherein the one or more processors, individually or in combination, are further configured to:
communicate an indication of at least one of: a quantity of polar code channels (N) or a quantity of blocks of u-domain bits (l).

12. The apparatus of claim 11, wherein the quantity of blocks of u-domain bits (l) is a function of a quantity of frequency hops associated with the transmission of the encoded data.

13. The apparatus of claim 1, wherein the one or more processors, individually or in combination, are further configured to:
communicate an indication of a physical resource block group (PRG) size, wherein a quantity of u-domain bits within the first block is based on the PRG size.

14. The apparatus of claim 1, wherein the one or more processors, individually or in combination, are further configured to:
rate-match the encoded data prior to transmission of the encoded data; and
refrain, for a time period and based on the rate-match, from puncturing the first u-domain bit or shortening the first u-domain bit when the encoded data is output for transmission.

15. The apparatus of claim 1, further comprising one or more transceivers configured to:
transmit the encoded data, wherein the apparatus is configured as a user equipment (UE) or a network entity.

16. An apparatus for wireless communication, comprising:
one or more memories, individually or in combination, having instructions; and
one or more processors, individually or in combination, configured to execute the instructions and cause the apparatus to:
decode encoded data to obtain at least a first block of u-domain bits comprising a first u-domain bit being a first frozen bit; and
measure a phase error associated with the first block based on a value of the first u-domain bit and a network-related value.

17. The apparatus of claim 16, wherein the first u-domain bit is a last u-domain bit within the first block of u-domain bits.

18. The apparatus of claim 16, wherein the encoded data is decoded via quadrature phase shift keying (QPSK), binary phase shift keying (BPSK), or π/2 BPSK.

19. The apparatus of claim 16, wherein the one or more processors, individually or in combination, are further configured to:
perform a channel estimation procedure to compute a phase error associated with the encoded data, wherein the phase error is used to decode the encoded data; and
update the channel estimation procedure if the value of the first u-domain bit does not match the network-related value.

20. The apparatus of claim 19, wherein the one or more processors, individually or in combination, are further configured to:
refrain, for a time period, from updating the channel estimation procedure if the value of the first u-domain bit matches the network-related value.

21. The apparatus of claim 19, wherein a mismatch between the first u-domain bit and the network-related value is indicative of a phase error of the first block, wherein the phase error is a function of π.

22. The apparatus of claim 16, wherein the encoded data is decoded to further determine multiple blocks of u-domain bits including the first block, wherein a last bit within each of the multiple blocks of u-domain is a frozen bit and indicates a phase associated with transmission of a corresponding block of the multiple blocks of u-domain bits.

23. The apparatus of claim 22, wherein each of the multiple blocks of u-domain bits is associated with one of multiple control channel elements (CCEs).

24. The apparatus of claim 16, wherein the one or more processors, individually or in combination, are further configured to:
communicate an indication of at least one of: a quantity of polar code channels (N) or a quantity of blocks of u-domain bits (l).

25. The apparatus of claim 24, wherein the quantity of blocks of u-domain bits (l) is a function of a quantity of frequency hops associated with obtaining the encoded data.

26. The apparatus of claim 16, wherein the one or more processors, individually or in combination, are further configured to:
communicate an indication of a physical resource block group (PRG) size, wherein a quantity of u-domain bits within the first block is based on the PRG size.

27. The apparatus of claim 16, further comprising one or more transceivers configured to:
receive the encoded data via the wireless communication, wherein the apparatus is configured as a user equipment (UE) or a network entity.

28. A method for wireless communication at a wireless node, comprising:
generating encoded data by using at least one of a first block of u-domain bits comprising a first u-domain bit being a frozen bit and further being indicative of a phase associated with transmission of the first block via the encoded data; and
outputting the encoded data for transmission.

29. The method of claim 28, further comprising:
setting a last bit within each of multiple blocks of u-domain bits to a network-related value, wherein the multiple blocks of u-domain bits include the first block of u-domain bits, and wherein each of the multiple blocks of u-domain bits is associated with one of multiple control channel elements (CCEs).
